(19) United States
(12) Patent Application Publication
(10) Pub. No.: US 2008/0219594 A1
(43) Pub. Date: Sep. 11, 2008

(54) IMAGE RESOLUTION CONVERTING METHOD AND DISPLAY APPARATUS APPLIED WITH THE SAME

(75) Inventor: In-Jae Yeo, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon (KR)

(21) Appl. No.: 12/040,491

(22) Filed: Feb. 29, 2008

(30) Foreign Application Priority Data
Mar. 7, 2007 (KR) 10-2007-0022489

(51) Int. Cl. G06K 9/32

(52) U.S. Cl. 382/299

(57) ABSTRACT

Disclosed are a method of converting an image resolution according to the machinery characteristics of a display apparatus and a display apparatus using the same. In accordance with an embodiment of the present invention, the image resolution converting method can include determining an image resolution of the input image; adjusting a vertical resolution of the image resolution of the input image to be identical to a vertical resolution of the output image; and adjusting a scanning time of a vertical line of the input image. With the present invention, it is possible to convert the resolution of the input image to a suitable resolution for the machinery characteristics of the display apparatus by using a few line memories instead of 1 frame memory before conversion and 1 frame memory after conversion.

### CROSS-REFERENCE TO RELATED PATENT APPLICATIONS

This application claims the benefit of Korean Patent Application No. 10-2007-0022489, filed on Mar. 7, 2007, in the Korean Intellectual Property Office, the disclosure of which is incorporated herein in its entirety by reference.

### BACKGROUND OF THE INVENTION

1. Field of the Invention

The present invention relates to a display apparatus, more specifically to a method of converting an image resolution according to the machinery characteristics of a display apparatus and a display apparatus using the same.

2. Background Art

While a conventional digital information processing method is impossible to process a large amount of data in real-time, an optical signal processing method can generally perform high-speed processing, parallel processing and large data amount processing. Also, studies on designs and manufactures of a binary phase filter, an optical logic gate, a light amplifier, a photoelectric element and an optical modulator by applying a spatial light modulation method are being developed. Particularly, the optical modulator is used in an optical memory, a light display, a printer, an optical interconnection and a hologram. A light beam scanning device using the optical modulator is being developed.

The light beam scanning device functions as forming a picture image by scanning a light beam in an image forming device such as a laser printer, an LED printer, an electronic photocopier, a word processor and a projector and spotting the light beam on a photosensitive medium.

As a projection television has been recently developed, an optical modulator and a scanner are being used as means that scans a light beam on a screen. The optical modulator outputs a modulated beam of light corresponding to the beam of light incident from the light source. Here, the modulated beam of light outputted by the optical modulator corresponds to a one-dimensional image (i.e. vertical scanning line or a horizontal scanning line) formed by allowing a plurality of micro-mirrors to be arranged in a line and each of the micro-mirrors to deal with one pixel. The scanner scans the modulated beam of light transferred from the optical modulator in a predetermined direction. This causes a plurality of one-dimensional image to be continually displayed. Finally, two-dimensional image is displayed on a screen.

The vertically directional resolution of the display apparatus including the foregoing optical modulator and scanner is fixed according to the number of pixels of the optical modulator (e.g. the number of micro-mirrors in case that one micro-mirror displays one pixel). Accordingly, it is necessary to convert a vertically directional resolution of an input image to a resolution corresponding to the pixel number of the optical modulator in order to fill an overall screen with the input image having the vertically directional resolution.

### SUMMARY OF THE INVENTION

Accordingly, the present invention provides a display apparatus and a resolution converting method that display an input image by maintaining a horizontally directional resolution of the input image and converting a vertically directional resolution to a suitable resolution for an output device.

The present invention also provides a digital type resolution converting method and a display apparatus applied with the same that converts a vertically directional resolution of an input image by using a minimum resource (e.g. a memory).

An aspect of the present invention features a method of converting an image resolution of an input image to a suitable resolution for an output image outputted by a display apparatus.

The image resolution converting method can include determining an image resolution of the input image; adjusting a vertical resolution of the image resolution of the input image to be identical to a vertical resolution of the output image; and adjusting a scanning time of a vertical line of the input image.

Here, in the step of adjusting the scanning time of the vertical line, the scanning time can be determined by using the vertical resolution of the input image adjusted to be identical to the vertical resolution of the output image according to a vertical and horizontal ratio of the input image.

Alternatively, in the step of adjusting the scanning time of the vertical line, the scanning time can be determined according to a value that is evaluated by dividing a width of the output image by a horizontal resolution of the input image.

The step of adjusting the scanning time of the vertical line can include computing a greatest common denominator of the vertical resolution of the input image and the vertical resolution of the output image; allotting input line memories in the quantities corresponding to the greatest common denominator and the vertical resolution of the input image and output line memories in the quantities corresponding to the greatest common denominator and the vertical resolution of the output image; receiving pixel data of the input image successively; performing a vertical resolution conversion if lines in the quantities of a predetermined number of the input line memories are filled; and repeating the receiving step and the conversion performing step.

Here, in the line memory allotting step, the input line memories in the quantities of {(the vertical resolution of the input image)/(the greatest common denominator)+1} can be allotted and the output line memories in the quantities of {2×(the vertical resolution of the output image)/(the greatest common denominator)} can be allotted. Adjusting a vertical resolution of one image frame can be completed by repeating the repeating step as many times as the greatest common denominator.

If the input image is contracted according to the output image, the vertical resolution of the input image can be contracted in the vertical resolution adjusting step and the scanning time is shortened in the scanning adjusting step. If the input image is enlarged according to the output image, the vertical resolution of the input image can be enlarged in the vertical resolution adjusting step and the scanning time is lengthened in the scanning adjusting step.

Another aspect of the present invention features a display apparatus converting the image resolution of an input image according to the image resolution of an output image.

The display apparatus can include a projection unit, loading image information corresponding to an image control signal on a beam of light emitted from a light source and projecting the beam of light on a screen; and an image processing unit, receiving an image signal of an frame, converting an image resolution of an input image corresponding to the image signal, inputted according to the image resolution of the output image, to a suitable resolution for a physical characteristic of the projection unit, generating the image control signal corresponding to the converted input image; and outputting the generated image control signal to the projection unit.

Here, the image processing unit can include a vertical resolution adjusting unit, converting the vertical resolution of the input image to be identical to the vertical resolution of the output image; and a horizontal resolution adjusting unit, adjusting a width of the input image to be projected through the projection unit by adjusting a scanning time of a vertical line of the input image.

The horizontal resolution adjusting unit can determine the scanning time by using the vertical resolution of the input image adjusted to be identical to the vertical resolution of the output image according to a vertical and horizontal ratio of the input image. Also, the horizontal resolution adjusting unit can determine the scanning time according to a value that is evaluated by dividing a width of the output image by a horizontal resolution of the input image.

The vertical resolution adjusting unit can include an image analyzing unit, computing a greatest common denominator of the vertical resolution of the input image and the vertical resolution of the output image; a memory allotting unit, allotting input line memories in the quantities corresponding to the greatest common denominator and the vertical resolution of the input image and output line memories in the quantities corresponding to the greatest common denominator and the vertical resolution of the output image; an input unit, receiving pixel data of the input image successively; and a conversion performing unit, performing a vertical resolution conversion if lines in the quantities of a predetermined number included in the input line memories are filled. The memory allotting unit can allot the input line memories in the quantities of {(the vertical resolution of the input image)/(the greatest common denominator)+1}. Also, the memory allotting unit can allot the input line memories in the quantities of {2×(the vertical resolution of the output image)/(the greatest common denominator)}. The conversion performing unit can complete adjusting a vertical resolution of one image frame by repeating the vertical resolution conversion as many times as the greatest common denominator.

The projection unit can include an optical modulator, outputting a modulated beam of light corresponding to an linear image by modulating an incident beam of light according to an inputted driving signal; a driving circuit, converting the inputted image control signal to the driving signal and outputting the driving signal to the optical modulator; a scanner, rotating according to a scanner control signal to scan the modulated beam of light transferred from the optical modulator on a screen and displaying a two-dimensional image; and the light source, emitting the incident beam of light to the modulator according to an inputted light source control signal. Here, the image processing unit can control an image projection performed by the optical modulator by providing the light source and the scanner with the light source control signal and the scanner control signal, synchronized with the image control signal.

Here, the optical modulator can include a plurality of micro-mirrors, arranged in a line to reflect the incident beam of light; and driving means, moving the micro-mirrors up and down according to the driving signal. Here, each of the micro-mirrors deals with a pixel of the screen.

### BRIEF DESCRIPTION OF THE DRAWINGS

These and other features, aspects and advantages of the present invention will become better understood with regard to the following description, appended Claims and accompanying drawings where:

FIG. 1 is a simplified diagram illustrating a display apparatus in accordance with an embodiment of the present invention;

FIG. 2A is a perspective view showing a type of a diffractive optical modulator module using a piezoelectric element applicable to an embodiment of the present invention;

FIG. 2B is a perspective view showing another form of a diffractive optical modulator module using a piezoelectric element applicable to an embodiment of the present invention;

FIG. 2C is a plan view showing a diffractive optical modulator array applicable to an embodiment of the present invention;

FIG. 2D is a schematic view showing a screen generated with an image by a diffractive optical modulator array applicable to an embodiment of the present invention;

FIG. 3 shows a one-dimensional linear image in accordance with the present invention;

FIG. 4 is a simplified block diagram illustrating a resolution converting module included in an image processing unit in accordance with an embodiment of the present invention;

FIG. 5A through FIG. 5C show an example of a contracted or enlarged input image in accordance with an embodiment of the present invention;

FIG. 6 shows an example of the conversion of a horizontal resolution in accordance with an embodiment of the present invention;

FIG. 7 shows an example of the conversion of a vertical resolution in accordance with an embodiment of the present invention;

FIG. 8A through FIG. 8C show an example of an image that has undergone a resolution converting module in accordance with an embodiment of the present invention;

FIG. 9 illustrates the method of contracting one original linear image (i.e. vertical image) and converting the contracted image to one conversion linear image of a conversion image;

FIG. 10 illustrates the method of enlarging one original linear image (i.e. vertical image) and converting the contracted image to one conversion linear image of a conversion image;

FIG. 11 is a flowchart illustrating an image resolution converting method in accordance with an embodiment of the present invention; and

FIG. 12 illustrates the method of storing and reading pixel data in and from a memory when the image resolution is converted in accordance with the present invention.

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, some embodiments of the present invention will be described in detail with reference to the accompanying drawings.

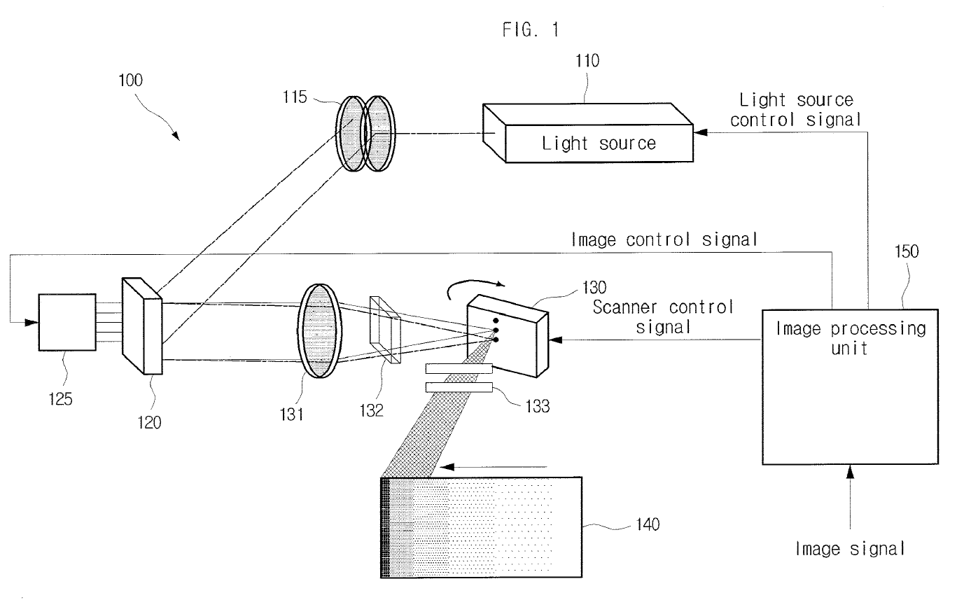

FIG. 1 is a simplified diagram illustrating a display apparatus in accordance with an embodiment of the present invention.

Referring to FIG. 1, the display apparatus 100 can include a light source 110, an optical modulator 120, a driving circuit 125, a scanner 130 and an image processing unit 150. In accordance with an embodiment of the present invention, the light source 110, the modulator 120, the driving circuit 125 and the scanner 130 can be included in a projection unit of the display apparatus 100.

The light source 110 can emit a beam of light to allow an image to be projected on a screen 140. The light source 110 can emit a white beam of light or any one of a red beam, a green beam and a blue beam of light, which are the three primary colors of light. Herein, the light source 110 can employ light amplification by stimulated emission of radiation (LASER), a light-emitting diode (LED) or a laser diode. In the case of emitting the white light, a color dividing unit (not shown) can be provided to divide the white beam of light into the red beam, the green beam and the blue beam of light.

Also, the light source 110 can include a red light source, a green light source and a blue light source. The light source 110 can emit the red, green and blue beams of light by repeating on/off successively or arbitrarily in order to project a color image on the screen 140.

A lighting optical system 115 can be placed between the light source 110 and the optical modulator 120. The lighting optical system 115 can reflect the light emitted from the light source 110 at a predetermined angle in order to allow the light to be concentrated on the optical modulator 120. If colors are divided by a color dividing unit (not shown), the operation of allowing the light to be concentrated can be additionally performed.

The optical modulator 120 can output modulated light according to a driving signal supplied from the driving circuit 125. The modulated light is the light emitted from the light source 120, which has undergone the modulation. The optical modulator 120, which is configured to include a plurality of micro-mirrors arranged in a line, can deal with a one-dimensional linear image corresponding to a vertical scanning line or a horizontal scanning in one image frame. In other words, when it comes to the one-dimensional linear image, the optical modulator 120 can output modulated light corresponding to incident light having a changed luminance by adjusting each displacement of the micro-mirrors corresponding to each pixel of the one-dimensional linear image according to a supplied driving signal.

In other words, the modulated light can be the one-dimensional linear image having an image frame. At this time, image information of the pixels included in one line of the image frame can be arranged in a line. The modulated light outputted from the optical modulator 120 can be the one-dimensional linear image of the vertical scanning line or the horizontal scanning line. The below description is related to the one-dimensional linear image of the vertical line for the convenience of understanding and description.

The number of a plurality of micro-mirrors can be identical to that of a pixel constituting a vertical line of the image frame or its multiple. The modulated light, which is the light applied with image information (i.e. a luminance value of each pixel constituting a vertical scanning line) of a vertical scanning line to be projected later on the screen 140, can be 0^{th}, +n^{th} or −n^{th} order diffracted (reflected) light, n being a natural number.

The driving circuit 125 can supply to the optical modulator 120 a driving signal changing the luminance of modulated light outputted according to an image control signal supplied from the image processing unit 150. The driving signal that the driving circuit 125 supplies to the optical modulator 120 can be a driving voltage or a driving circuit.

A focusing optical system 131 can allow the modulated light outputted from the optical modulator 120 to be transferred to the scanner 130. The focusing optical system 131 can include at least one lens. Also, the relay optical system 350 adjusts the magnification, as necessary, to transfer the modulated light enlarged or contracted according to the size ratio of the optical modulator 120 and the scanner 130.

The scanner 130 can reflect modulated light incident from the optical modulator 120 at a predetermined angle and projects the light on the screen 140. At this time, the predetermined angle can be determined by a scanner control signal inputted from the image processing unit 150. The scanner control signal can be synchronized with an image control signal and allow the scanner 130 to be rotated at an angle. At this time, the modulated light can be projected on a vertical line position on the screen 140 corresponding to the scanner control signal at the angle.

In particular, the scanner control signal can include information related to a scanning speed and a scanning angle. The scanner 130 can be rotated according to the scanning angel and speed in order that the modulated light incident from the optical modulator 120 can be projected on a position on the screen 140 at a time. The scanner 360 can be a polygon mirror, a rotating bar, or a Galvano mirror, for example.

The modulated light transferred from the optical modulator 120, as described above, can 0^{th}, +n^{th} or −n^{th} order diffracted light. Each diffracted light can be projected on the screen 140 by the scanner 130. In this case, since the path of each diffracted light is different, a slit 133 can be included. The slit 133 can allow desired order diffracted light to be selected and to be projected on the screen 140. Further, the desired order diffracted light among the modulated light to be incident to the scanner 130 can be incident to the screen 130 by allowing the slit 133 to be placed in front of the scanner 130.

A projection optical system 132 can allow the modulated transferred from the optical modulator 120 to be projected on the scanner 130. Herein, the projection optical system 132 can include a projection lens (not shown).

The image processing unit 150 can receive an image signal corresponding to one image frame and recognize the vertical resolution and the horizontal resolution of an input image corresponding to the inputted image signal. Then, the image processing unit 150 can convert the vertical resolution of the input image to a resolution according to the physical characteristics of the optical modulator 120. Here, the physical characteristics of the optical modulator 120 can include the number of pixels included in the light modulated by the optical modulator 120 and/or the number of micro-mirrors included in the optical modulator 120.

The image processing unit 150 can also provide a scanner control signal and a light source control signal to the scanner 130 and the light source 110, respectively. At this time, the scanner control signal and the light source controlling sign can be synchronized with an image control signal. One image frame can be displayed on the screen 140 by the image control signal, the scanner control signal and the light source control signal, which are linked with each other.

Here, the image control signal can include information related to the horizontal resolution of the input image. The information related to the horizontal resolution of the input image can include a time which it takes for the scanner to scan each vertical line on the screen 140. As described above, while the horizontal resolution of the input image is unchangeable, the scanning time can be varied according to the vertical resolution changed in accordance with the physical characteristics of the optical modulator 120.

For example, it is assumed that the input image has the resolution of 800×600 (i.e. the horizontal resolution of 800 and the vertical resolution of 600). If the optical modulator has 480 micro-mirrors, the vertical resolution of the input image is required to be changed from 600 to 480. In order that the ratio of the size of vertical direction to the size of horizontal direction of the input image (hereinafter, referred to as ‘vertical and horizontal ratio’) is set to be constant, the horizontal resolution is required to be changed as much as the change of the vertical resolution.

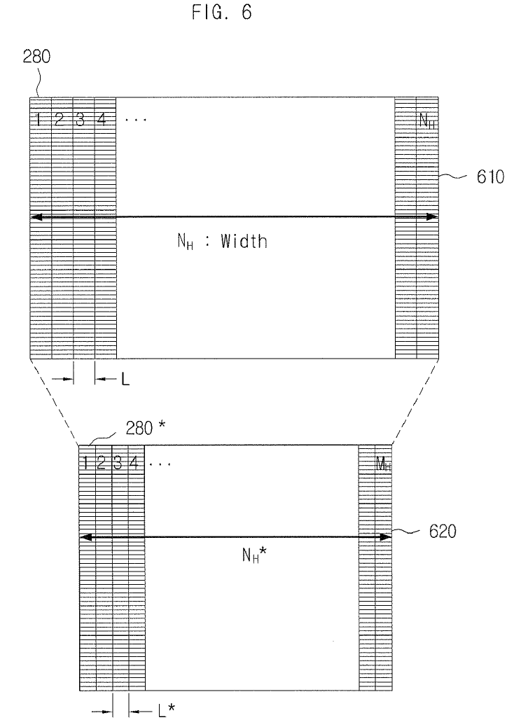

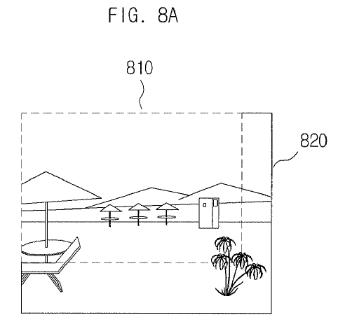

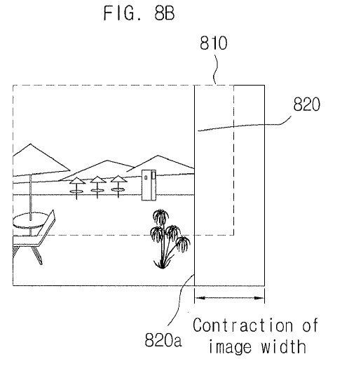

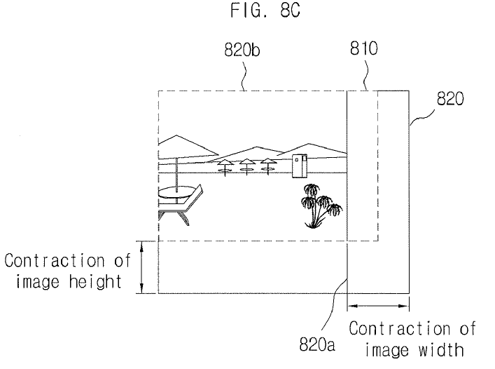

In this case, the horizontal resolution of 800 may not be changed, but the vertical and horizontal ratio of an image projected on the screen 140 can be the same as that of the input image by reducing the scanning time of each vertical line as much as 480/600. This will be described later in detail with reference to FIG. 6 though FIG. 8.

The image processing unit 150 can provide the driving circuit 125 with an image control signal corresponding to luminance information to be desired to be displayed for each pixel forming an image frame and adjust the scanning angle and the scanning speed of the scanner 130 to allow the vertical line to be projected on the screen 140 according to the image control signal.

The method of generating an image control signal, that is, the method of controlling the vertical resolution and/or the horizontal resolution of an input image will be described later with reference to the related drawings.

Below is described the optical modulator 120 applicable to the present invention.

The spatial optical modulator is mainly divided into a direct type, which directly controls the on/off state of light, and an indirect type, which uses reflection and diffraction. The indirect type can be further divided into an electrostatic type and a piezoelectric type. Here, the optical modulator is applicable to the present invention regardless of the operation type.

An electrostatic type grating optical modulator includes a plurality of regularly spaced reflective ribbons having reflective surfaces and suspended above an upper part of the substrate, the spaced distances of the reflective ribbons being adjustable.

First, an insulation layer is deposited onto a silicon substrate, followed by depositions of a silicon dioxide film and a silicon nitride film. Here, the silicon nitride film is patterned with the ribbons, and some portions of the silicon dioxide film are etched such that the ribbons can be maintained by a nitride frame on an oxide spacer layer.

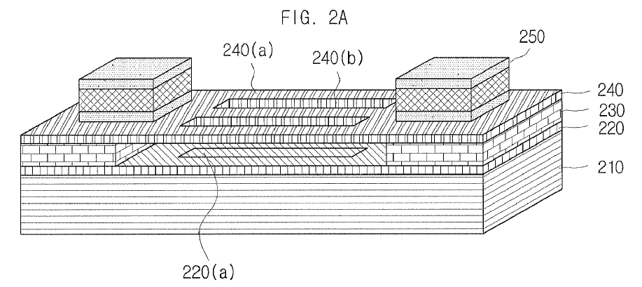

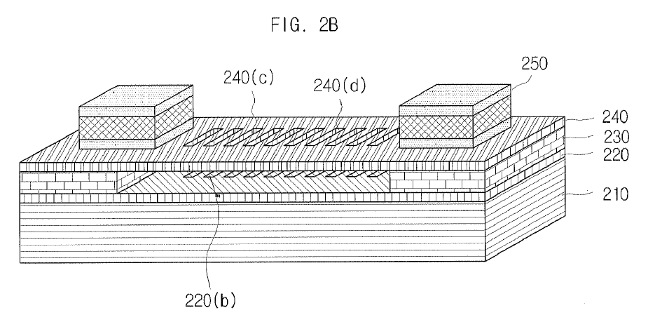

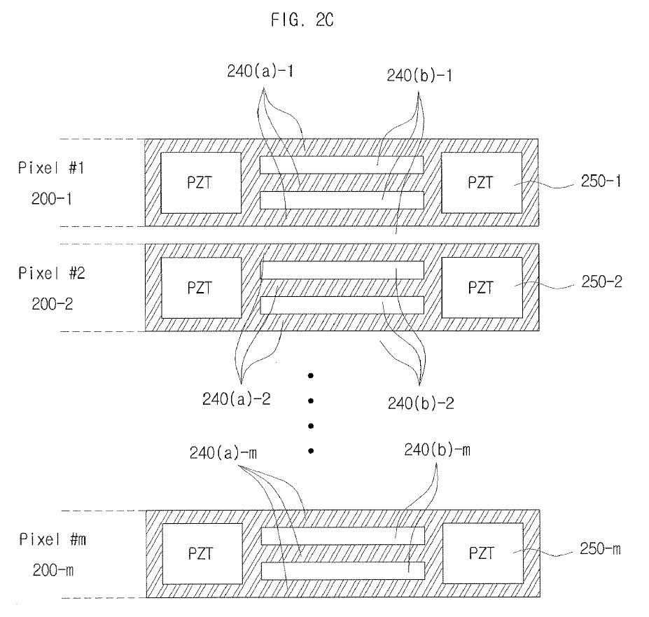

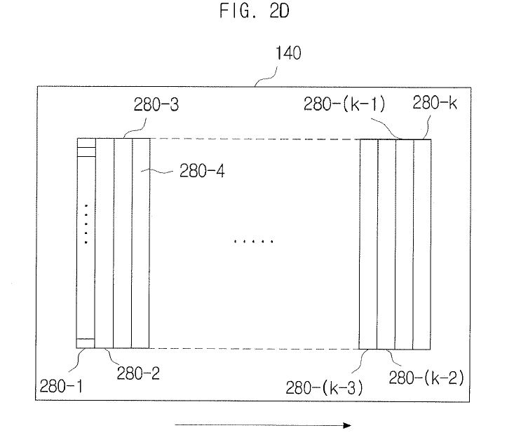

The grating amplitude, of the modulator limited to the vertical distance d between the reflective surfaces of the ribbons and the reflective surface of the substrate, is controlled by supplying a voltage between the ribbons (i.e. the reflective surface of the ribbon, which acts as a first electrode) and the substrate (i.e. the conductive film at the bottom portion of the substrate, which acts as a second electrode). FIG. 2A is a perspective view showing a type of a diffractive optical modulator module using a piezoelectric element applicable to an embodiment of the present invention, and FIG. 2B is a perspective view showing another form of a diffractive optical modulator module using a piezoelectric element applicable to an embodiment of the present invention. Referring to FIG. 2A and FIG. 2B, the micro-mirror including a substrate 210, an insulation layer 220, a sacrificial layer 230, a ribbon structure 240 and a piezoelectric elements 250 is illustrated.

The substrate 210 is a commonly used semiconductor substrate, and the insulation layer 220 is deposited as an etch stop layer. The insulation layer 220 is formed from a material with a high selectivity to the etchant (an etching gas or an etching solution) that etches the material used as the sacrificial layer 230. Here, a lower reflective layer 220(a) or 220(b) can be formed on the insulation layer 220 to reflect incident beams of light.

The sacrificial layer 230 supports the ribbon structure 240 at opposite sides such that the ribbon structure 240 can be spaced by a constant gap from the insulation layer 220, and forms a space in the center part.

The ribbon structure 240 creates diffraction and interference in the incident light to perform optical modulation of signals. The ribbon structure 240 can be formed in a plurality of ribbon shapes, or can include a plurality of open holes 240(b) or 240(d) in the center portion of the ribbons. Also, the piezoelectric element 250 controls the ribbon structure 240 to move upwardly and downwardly according to upward and downward, or leftward and rightward contraction or expansion levels generated by the difference in voltage between the upper and lower electrodes. Here, the lower reflective layer 220(a) or 220(b) is formed in correspondence with the holes 240(b) or 240(d) formed in the ribbon structure 240.

For example, in case that the wavelength of a beam of light is λ, a first power is supplied to the piezoelectric elements 250. At this time, the first power allows the gap between an upper reflective layer 240(a) or 240(c), formed on the ribbon structure 240, and the lower reflective layer 220(a) or 220(b), formed on the insulation layer 220, to be equal to (2j)λ/4, k being a natural number. In the case of a 0^{th}-order diffracted (reflected) beam of light, the overall path length difference between the light reflected by the upper reflective layer 240(a) or 240(c) and the light reflected by the lower reflective layer 220(a) or 220(b) is equal to jλ, so that constructive interference occurs and the diffracted light renders its maximum luminance. In the case of +1^{st} or −1^{st} order diffracted light, however, the luminance of the light is at its minimum value due to destructive interference.

Also, a second power is supplied to the piezoelectric elements 250. At this time, the first power allows the gap between an upper reflective layer 240(a) or 240(c), formed on the ribbon structure 240, and the lower reflective layer 220(a) or 220(b), formed on the insulation layer 220, to be equal to (2j+1)λ/4, k being a natural number. In the case of a 0^{th}-order diffracted (reflected) beam of light, the overall path length difference between the light reflected by the upper reflective layer 240(a) or 240(c) formed on the ribbon structure 240 and the light reflected by the insulation layer 220 is equal to (2j+1)λ/2, so that destructive interference occurs, and the diffracted light renders its minimum luminance. In the case of +1^{st} or −1^{st} order diffracted light, however, the luminance of the light is at its maximum value due to constructive interference.

As a result of such interference, the micro-mirror can load a signal for one pixel on the beam of light by adjusting the quantity of the reflected or diffracted light. Although the foregoing describes the cases in which the gap between the ribbon structure 240 and the insulation layer 220 is (2j)λ/4 or (2j+1)λ/4, it shall be obvious that a variety of embodiments can be applied to the present invention, in which adjusting the gap between the ribbon structure 240 and the insulation layer 220 is able to control the luminance of light interfered by diffraction and/or reflection of the incident light.

The below description is related to the micro-mirror shown in FIG. 2A. Hereinafter, the 0^{th}, +n^{st} or −n^{st} order diffracted (or reflected) light is referred to as modulated light. Here, n is a natural number.

FIG. 2C is a plan view showing the optical modulator 120 including the plurality of micro-mirrors shown in FIG. 2A.

Referring to FIG. 2C, the optical modulator 120 is configured to include m micro-mirrors 100-1, 100-2, . . . , and 100-m, each of which corresponds to a first pixel (pixel #1), a second pixel (pixel #2), . . . , and an m^{th} pixel (pixel #m), respectively, m being a natural number. The optical modulator 120 deals with image information with respect to 1-dimensional images of vertical or horizontal scanning lines (which are assumed to consist of m pixels), while each micro-mirror 100 deals with one pixel among the m pixels constituting the vertical or horizontal scanning line. Thus, the light reflected or diffracted by each micro-mirror is later projected as a 2-dimensional image on a screen by an optical scanning device.

While the below description is related to the principle of optical modulation based on the first pixel (pixel #1), the same can obviously apply to other pixels.

In the embodiment of the present invention, it is assumed that the number of holes 240(b)-1 formed in the ribbon structure 240 is two. The two holes 240(b)-1 allow three upper reflective layers 240(a)-1 to be formed on an upper part of the ribbon structure 240. On the insulation layer 220, two lower reflective layers are formed in correspondence with the two holes 240(b)-1. Also, another lower reflective layer in correspondence with the gap between the first pixel (pixel #1) and the second pixel (pixel #2) is formed on the insulation layer 220. Accordingly, the number of the upper reflective layers 240(a)-1 is identical to that of the lower reflective layers per pixel, and as described with reference to FIG. 2A, it is possible to control the luminance of the modulated light by using the modulated light (i.e. 0^{th}-order diffracted light or ±1^{st}-order diffracted light).

FIG. 2D is a schematic view showing a screen generated with an image by a diffractive optical modulator array applicable to an embodiment of the present invention.

In particular, FIG. 2D illustrates that the light reflected and/or diffracted by vertically arranged m micro-mirrors 200-1, 200-2, . . . , and 200-m to be reflected by an scanner and then scanned horizontally on the screen 140, to thereby generate pictures 280-1, 280-2, 280-3, 280-4, . . . , 280-(k−3), 280-(k−2), 280-(k−1), and 280-k. One image frame can be projected in the case of one rotation of the optical scanning device. Here, although the scanning is performed from the left to the right (i.e. the direction indicated by the arrow), it is apparent that images can be scanned in another direction (e.g. in the opposite direction).

The present invention can be applied to the display apparatuses including the aforementioned one-dimensional diffractive optical modulator. Also, the present invention can be applied to the mobile display apparatuses, which are the projection type display apparatuses, included in the portable electronic apparatuses having various multimedia functions (e.g. mobile phones, personal digital assistants (PDA) and laptop computers).

Hereinafter, the method and the principle of converting the image resolution of an input image corresponding to an image signal inputted in the image processing unit 150 will be described in detail with reference to the related drawings.

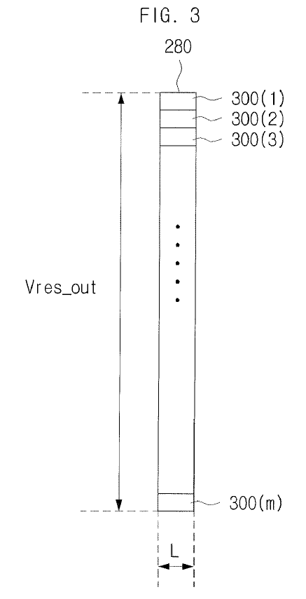

FIG. 3 shows a one-dimensional linear image in accordance with the present invention.

Referring to FIG. 3, the one-dimensional linear image 280 can be projected on a predetermined position of a screen at a time. In case that the optical modulator 120 includes m micro-mirrors and one micro-mirror deals with one pixel as shown in FIG. 3C, the one-dimensional linear image 280 can be formed to include m pixels 300(1), 300(2), . . . and 300(m). Also, the one-dimensional linear image 280 can be scanned during a period of time. The scanning time can be in proportion to the width L of the one-dimensional linear image 280.

In case that the overall screen is desired to be filled with images, the vertical resolution of the input image can be required to be converted to m according to the physical characteristics (e.g. the number of micro-mirrors) of the optical modulator 120 included in the display apparatus 100 in accordance with an embodiment of the present invention. Hereinafter, the vertical resolution m of the input image determined by the optical modulator 120 is referred to as Vres_out.

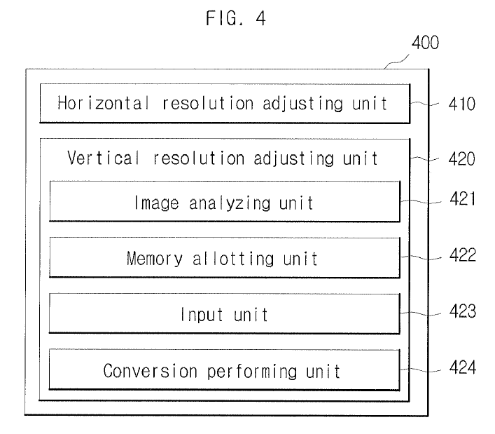

FIG. 4 is a simplified block diagram illustrating a resolution converting module 400 included in an image processing unit in accordance with an embodiment of the present invention.

After an image signal is received in the image processing unit 150, the vertical resolution of the image can be changed by allowing the image signal to undergo the resolution converting module 400. After that, an image control signal, a scanner control signal and a light source control signal can be generated and outputted to control the optical modulator 120, the scanner 130 and the light source 110.

The resolution converting module 400 can include a horizontal resolution adjusting unit 410 and a vertical resolution adjusting unit 420.

The resolution converting module 400 can independently adjust a horizontally directional resolution and a horizontally directional resolution or adjust a horizontally directional resolution in accordance with a horizontally directional resolution.

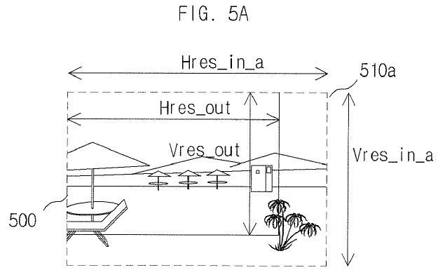

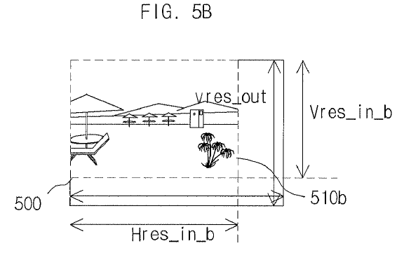

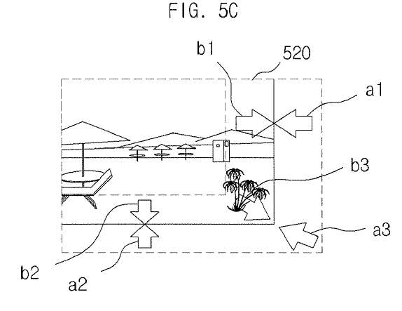

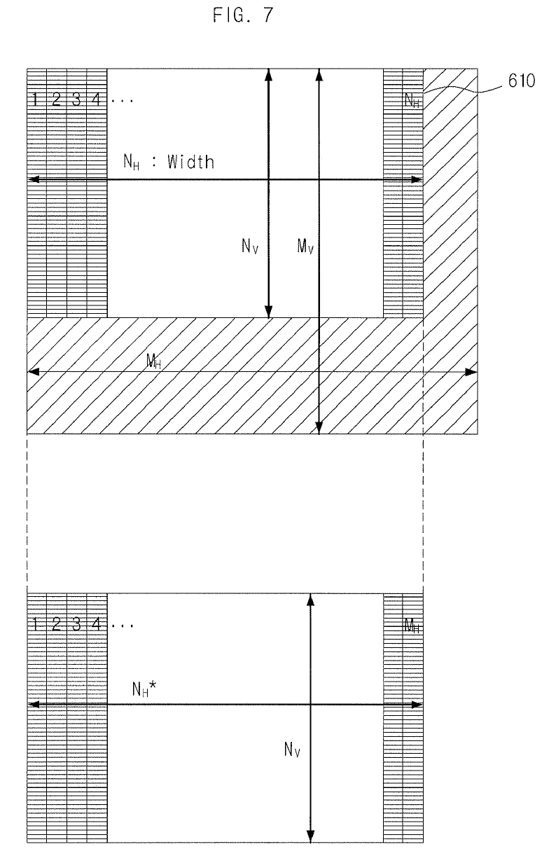

FIG. 5A through FIG. 5C show an example of a contracted or enlarged input image in accordance with an embodiment of the present invention, and FIG. 6 shows an example of the conversion of a horizontal resolution in accordance with an embodiment of the present invention. FIG. 7 shows an example of the conversion of a vertical resolution in accordance with an embodiment of the present invention.

Referring to FIG. 5A, an output image 500 can be displayed on the screen 140 according to the physical characteristics of the optical modulator 120 of the display apparatus 100 in accordance with an embodiment of the present invention. The output image 500 can have the vertical resolution Vres_out and the horizontal resolution Hres_out. Correspondingly, an input image 510a can have the vertical resolution Vres_in_a and the horizontal resolution Hres_in_a.

Since Vres_in_a>Vres_out and Hres_in_a>Hres_out, as shown in FIG. 5C, the input image 510a can undergo the horizontally directional resolution conversion a1 and the vertically directional resolution conversion a2. As a result, the input image 510a can be converted to a conversion image 520 through the contraction a3. The conversion image 520 can be included in the size of the output image 500 displayed in the screen 140.

Referring to FIG. 5B, the output image 500 can be displayed on the screen 140 according to the physical characteristics of the optical modulator 120 of the display apparatus 100 in accordance with an embodiment of the present invention. The output image 500 can have the vertical resolution Vres_out and the horizontal resolution Hres_out. Correspondingly, an input image 510b can have the vertical resolution Vres_in_b and the horizontal resolution Hres_in_b.

Since Vres_in_b<Vres_out and Hres_in_b<Hres_out, as shown in FIG. 5C, the input image 510b can undergo the horizontally directional resolution conversion b1 and the vertically directional resolution conversion b2. As a result, the input image 510b can be converted to the conversion image 520 through the enlargement b3. The conversion image 520 can be included in the size of the output image 500 displayed in the screen 140.

The horizontal resolution adjusting unit 410 can convert the horizontal resolution of the input image 510a or 510b to the suitable resolution for the output image 500. The images can be displayed on the overall screen 140 by adjusting the horizontally directional line output time (i.e. the emitting time of the one-dimensional linear image). In case that the vertical resolution of input image is converted, the horizontal resolution adjusting unit 410 can balance the vertical and horizontal ratio of the input image or convert the horizontal resolution of the input image to the suitable resolution for the horizontally directional size of the screen 140.

Below will be described the horizontal resolution converting method with reference to FIG. 6.

1. The method of balancing the vertical and the horizontal ratio of the input image.

It is assumed that the image resolution of the output image 610 of the display apparatus 100 in accordance with the present invention is N_{H}×N_{V}. Here, N_{V} is the number of pixels forming the one-dimensional linear image 280, which is the number of micro-mirrors included in the optical modulator 120, and N_{H} is the number of one-dimensional linear images 280, which is the horizontal resolution Hres_out.

In the present invention, it is also assumed that the width L of the one-dimensional linear image 280, which is the scanning time T_{L} of the one-dimensional linear image 280, according to the physical characteristics (e.g. the number of pixels included in the one-dimensional linear image 280) of the optical modulator 120.

The width L_{H} of a two-dimensional output image 610 can be N_{V}×L.

In case that the image resolution of an input image to be inputted and displayed is M_{H}×M_{V}, if the vertical resolution M_{V} is converted to be suitable for the physical characteristics of the optical modulator 120, the horizontal resolution M_{H} may be projected as it is in order to balance the vertical and horizontal ratio of the input image, and the width L_{H}* of the image can be evaluated by the following formula 1.

M_{V}:M_{H}=N_{V}:L_{H}* [Formula 1]

In other words, the scanning angle and/or the scanning speed of the scanner 130 can be adjusted to satisfy the formula L_{H}*=M_{H}×N_{V}/M_{V}. Here, L_{H}* can be the same as or smaller than L_{H}. This is because the final conversion image 260 is required to be included in the output image 610 in order to be represented by the display apparatus 100 of the present invention.

In this case, since the overall scanning time of the output image 610 is required to be the same as that of the one-time-converted image 620 having the adjusted width (i.e. having the changed horizontal resolution), the scanning time T_{L}* of the one-dimensional linear image 280* included in the one-time-converted image 620 can be evaluated by the following formula 2.

T_{L}*=T_{L}×N_{H}/M_{H} [Formula 2]

2. The method of converting the horizontal resolution of the input image to the suitable resolution for the horizontally directional size of the screen 140

As described above, the image resolution of the output image 610 is assumed to be N_{H}×N_{V}. The width L_{H} of the output image 610 can be N_{V}×L.

In case that the image resolution of an input image to be inputted and displayed is M_{H}×M_{V}, the width L_{H}* of the input image can be converted so as to be the same as the width L_{H} of the output image 610.

Since the resolution N_{V} of the output image 610 is different from the resolution M_{V} of the input image, the scanning time T_{L}* of the one-dimensional linear image 280* can be evaluated by the following formula 3.

T_{L}*=T_{L}×N_{V}/M_{V} [Formula 3]

In other words, since L_{H}*=L_{H}, the scanning angle and/or the scanning speed can be the same. However, the scanning time of each one-dimensional linear image 280* may be changed.

The vertical resolution adjusting unit 420 can convert the vertical resolution of the input image 510a or 510b to the suitable resolution for the output image 500. The vertical resolution adjusting unit 420 can include an image analyzing unit 421, computing the greatest common denominator of the vertical resolution of the input image 510a or 510b and the vertical resolution of the output image 500; a memory allotting unit 422, allotting input line memories in the quantities corresponding to the greatest common denominator and the vertical resolution of the input image 510a or 510b and output line memories in the quantities corresponding to the greatest common denominator and the vertical resolution of the output image 500; an input unit 423, receiving pixel data of the input image 510a or 510b successively; and a conversion performing unit 424, performing the vertical resolution conversion if lines of the input line memories in a predetermined quantities is filled. The operations and the functions of each element will be described below in detail with reference to the related drawings.

FIG. 7 illustrates the vertical resolution converting method.

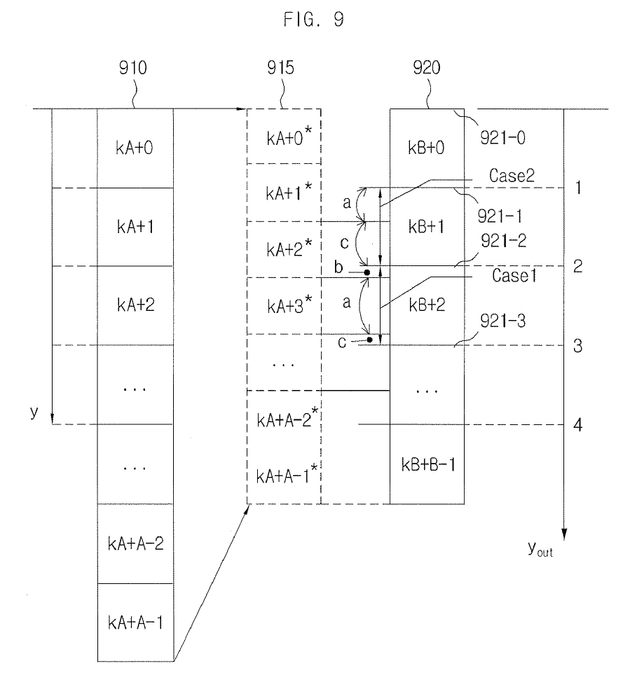

The resolution M_{V} of the input image can be converted to be the same as the resolution N_{V} of the output image 610. The vertical resolution conversion can increase the number of pixels in a vertical direction, in the case of the enlargement, and reduce the number of pixels in the vertical direction, in the case of the contraction. The vertical resolution conversion will be described in detail with reference to FIG. 9 and the related drawings.

The input image can undergo the horizontal resolution adjusting unit 410 and/or the vertical resolution adjusting unit 420 to allow its horizontal resolution and/or its vertical resolution to be converted to suitable resolutions for the physical characteristics of the optical modulator 120 in order to display the adequate two-dimensional image on the screen 140.

FIG. 8A through FIG. 8C show an example of an image that has undergone a resolution converting module in accordance with an embodiment of the present invention. In particular, FIG. 8A shows the input image, and FIG. 8B shows the input image which has undergone the horizontal resolution conversion. FIG. 8C shows the input image which has undergone the vertical resolution conversion.

For the convenience of understanding and description, the below description assumes that the input image 820 is larger than an output image 810 capable of being displayed in horizontal and the vertical directions in the display apparatus 100 of the present invention (refer to FIG. 8A).

In case that the resolution conversion of the input image 820 is performed, when the vertical resolution is converted, the vertical resolution of the input image 820 can be the same as that of the output image 810 according to the physical characteristics of the optical modulator 120. When the horizontal resolution is converted, the horizontal resolution can be converted in order that the vertical and horizontal ratio of the input image 820 can be balanced although the vertical resolution is converted or in order to be suitable for the width of the output image 810.

As a result, the final conversion image 820b can be displayed on the screen 140 by contracting the width in a horizontal direction (refer to 820a) and the height in a vertical direction (refer to 820b). The final conversion image 820b can be included in the output image 820, and each vertical directional size can be the same.

Hereinafter, the method of converting the vertical resolution will be described by separating the contraction conversion and the enlargement conversion.

The contraction conversion will be firstly described as follows.

FIG. 9 illustrates the method of converting one original linear image 910 (i.e. one vertical image) of the input images to one conversion linear image 920 of the conversion images by contracting the original linear image 920 at a ratio of p shown in the formula 4.

The image contraction ratio p can be represented as the formula 4.

p=B/A:Image contraction ratio(A>B)

yₒᵤₜ=KB+n; n=0,1,2, . . . , B−1, K=0,1, . . . , K−1 [Formula 4]

Here, K refers to the greatest common denominator of the vertical resolution M_{V} of the input image and the vertical resolution N_{V} of the conversion image (K×A M_{V}, K×B=N_{V}).

The original linear image 910 can be formed to include pixels in the quantities of A(=M_{V}/K) which is evaluated by using the greatest common denominator K and the vertical resolution M_{V} of the input image computed by the foregoing formula 4 among the one-dimensional linear images included in the input image. The conversion linear image 920 can be formed to include pixels in the quantities of B(=N_{V}/K) which is evaluated by using the greatest common denominator K and the vertical resolution N_{V} of the conversion image computed by the foregoing formula 4 among the one-dimensional linear images included in the conversion image.

According to the image contraction ratio, the contraction linear image 915 formed by contracting the pixels in the quantities of A included in the original linear image 910 can have the same length as the pixels in the quantities of B included in the conversion linear image 920. However, the pixels capable of being displayed on the screen 140 by the optical modulator 120 can be included in not the contraction linear image 915 but the conversion linear image 920.

Accordingly, the pixel data corresponding to each pixel included in the conversion linear image 920 can be computed from the pixel data corresponding to each pixel of the contraction linear image 915. The pixel data of the conversion linear image 920 can be computed by each method corresponding to three cases to be described below.

The length of one pixel of the conversion linear image 920 is assumed to be 1. Also, a line 920-0 of a first pixel KB+0 in the conversion linear image 920 can be determined as a fiducial line 0, and the delimitation lines 921-1, 921-2, 921-3, . . . between each pixel can be determined as successive integers and referred to as an yₒᵤₜ axis.

[U(y)−p]=[U(y)] Case 1

Here, [k] is the greatest one of the integers less than or equal to k as one of the mathematical symbols. U(y) indicates the value when the contraction linear image 915 is corresponded to the yₒᵤₜ t axis, and p indicates the length of one pixel (KA+0*, KA+1*, . . . ) when the contraction linear image 915 is corresponded to the yₒᵤₜ axis.

The case 1 can indicate the case in which one pixel of the contraction linear image 915 is included in one pixel of the conversion linear image 920. For example, in the case of the pixel KA+3* of the contraction linear image 915, opposite outlines of the pixel KA+3* can be included in the pixel KB+2 of the conversion linear image 920.

In this case, the pixel data of the pixel KB+2 of the conversion linear image 920 can be determined by the pixels KA+2*, KA+3* and KA+4*, which are partially in contact with the pixel KB+2 according to the following formula 5.

P(yₒᵤₜ)=b×P(y−1)+a×P(y)+c×P(y+1) [Formula 5]

a=p, b=U(y)−p−[U(y)], c=1−a−b

Here, P(yₒᵤₜ) is the pixel data of the pixel at the position yₒᵤₜ after conversion and is determined by three pixel items of information at the positions y−1, y and y+1 (e.g. y=KA+3*) before conversion.

U(y)−[U(y)]<p [symbol] , U(y)−[U(y)]+p>1 Case 2

The case 2 can indicate the case in which any one of pixels included in the contraction linear image 915 is not completely included in one pixel of the conversion linear image 920, but two successive pixels of the contraction linear image 915 are partially in contact with one pixel of the conversion linear image 920. For example, the two pixels KA+1* and KA+2* of the contraction linear image 915 can be partially in contact with the pixel KB+1 of the conversion linear image 920.

In this case, the pixel data of the pixel KB+1 of the conversion linear image 920 can be determined by the two pixels KA+1* and KA+2* of the contraction linear image 915 according to the following formula 6.

P(yₒᵤₜ)=a′×P(y)+c′×P(y+1) [Formula 6]

a′=U(y)−[U(y)], c′=1−a′

Here, P(yₒᵤₜ) is the pixel data of the pixel at the position yₒᵤₜ after conversion and is determined by two pixel items of information at the positions y and y+1 (e.g. y KA+1*) before conversion.

U(y)−[U(y)]<p [symbol] , U(y)−[U(y)]+p<1 Case 3

The case 2 can indicate the case in which one pixel of the contraction linear image 915 is included in one pixel of the conversion linear image 920, similar to the case 1.

However, the pixel data of the conversion linear image 920 can computed by the following formula 7. In this case, the pixel data of the pixel KB+2 of the conversion linear image 920 can be determined by the pixels KA+2*, KA+3* and KA+4*, which are partially in contact with the pixel KB+2.

P(yₒᵤₜ)=b×P(y)+a×P(y+1)+c×P(y+2) [Formula 7]

a=p, b=U(y)−p−[U(y)], c=1−a−b

Here, P(yₒᵤₜ) is the pixel data of the pixel at the position yₒᵤₜ after conversion and is determined by three pixel items of information at the positions y, y+1 and y+2 (e.g. y=KA+2*) before conversion.

The vertical resolution conversion (i.e. contraction) can be performed by computing pixel data of each pixel of the conversion linear image 920 by use of pixel data of the contraction linear image 915 from the three forgoing cases.

While the above description is related to the contraction conversion, the below description is related to the enlargement conversion.

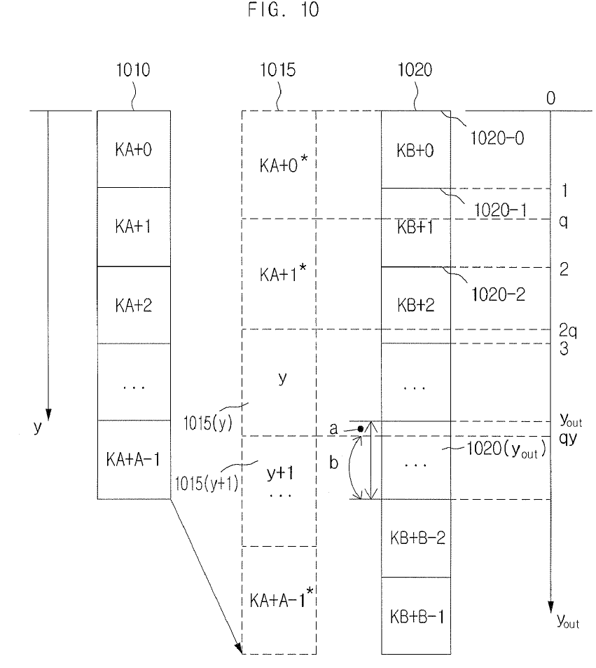

FIG. 10 illustrates the method of converting one original linear image 1010 (i.e. one vertical image) of the input images to one conversion linear image 1020 of the conversion images by enlarging the original linear image 920 at a ratio of q by the bilinear interpolation method. This will be described as follows.

The image enlargement ratio q can be represented as the formula 8.

q=B/A:Image contraction ratio(A<B)

yₒᵤₜ=KB+n; n=0,1,2, . . . , B−1, K=0,1, . . . , K−1 [Formula 8]

Here, K refers to the greatest common denominator of the vertical resolution M_{V} of the input image and the vertical resolution N_{V} of the conversion image (K×A=M_{V}, K×B=N_{V}).

The original linear image 1010 can be formed to include pixels in the quantities of A(=M_{V}/K) which is evaluated by using the greatest common denominator K and the vertical resolution M_{V} of the input image computed by the foregoing formula 8 among the one-dimensional linear images included in the input image. The conversion linear image 920 can be formed to include pixels in the quantities of B(=N_{V}/K) which is evaluated by using the greatest common denominator K and the vertical resolution N_{V} of the conversion image computed by the foregoing formula 8 among the one-dimensional linear images included in the conversion image.

According to the image enlargement ratio, the enlargement linear image 1015 formed by enlarging the pixels in the quantities of A included in the original linear image 1010 can have the same length as the pixels in the quantities of B included in the conversion linear image 1020. However, the pixels capable of being displayed on the screen 140 by the optical modulator 120 can be included in not the enlargement linear image 1015 but the conversion linear image 1020.

Accordingly, the pixel data corresponding to each pixel included in the conversion linear image 1020 can be computed from the pixel data corresponding to each pixel of the enlargement linear image 1015. The pixel data of the conversion linear image 1020 can be computed by the method to be described below.

The length of one pixel of the conversion linear image 1020 is assumed to be 1. Also, a line 1020-0 of a first pixel KB+0 in the conversion linear image 1020 can be determined as a fiducial line 0, and the delimitation lines 1021-1, 1021-2, . . . between each pixel can be determined as successive integers and referred to as an yₒᵤₜ axis. Here, [k] is the greatest one of the integers less than or equal to k as one of the mathematical symbols.

If a line or of a first pixel KB+0* in the enlargement linear image 1015 is determined as the fiducial line 0, the delimitation lines between each pixel of the enlargement linear image 1015 can be placed at points q, 2q, 3q . . . on the yₒᵤₜ axis.

P(yₒᵤₜ)=a×P(y)+b×P(y+1) [Formula 9]

yₒᵤₜ=[qy]

a=qy−[qy], b=1−a

Here, P(yₒᵤₜ) is the pixel data of the pixel 1020(yₒᵤₜ) at the position yₒᵤₜ of the conversion linear image 1020 after conversion and is determined by the pixel data of the pixels 1015(y), 1015(y+1) at the positions y and y+1 before conversion.

When it comes to the relation to other image processing operations, the foresaid resolution conversion can be performed by allowing the resolution of an inputted image signal to be firstly converted and then other image processing operations such as color tone correction, keystone correction and gamma control to be performed.

In the conventional art, the pixel data of all pixels corresponding to one frame is required to be inputted and the resolution conversion is required to be performed based on the inputted pixel data. Accordingly, at least two frame memories capable of storing the pixel data of all pixels corresponding to one frame are needed to store each data before and after conversion.

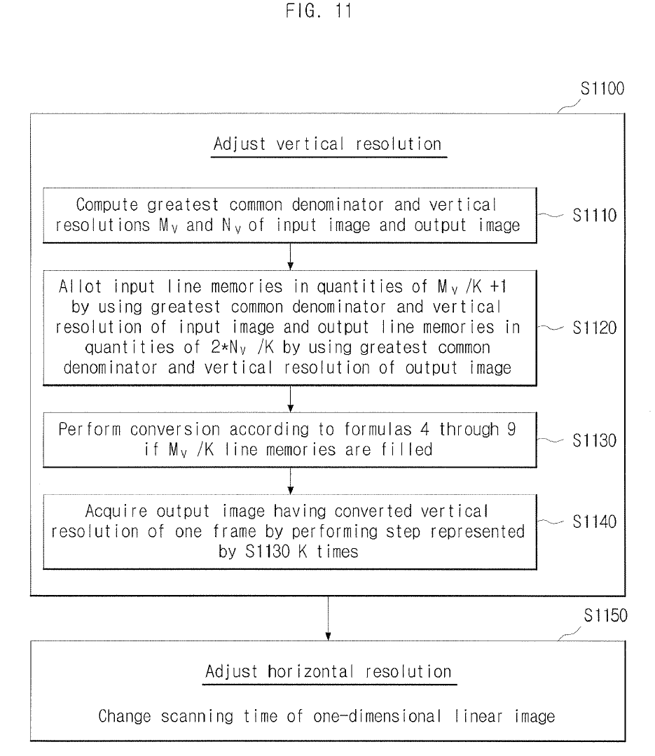

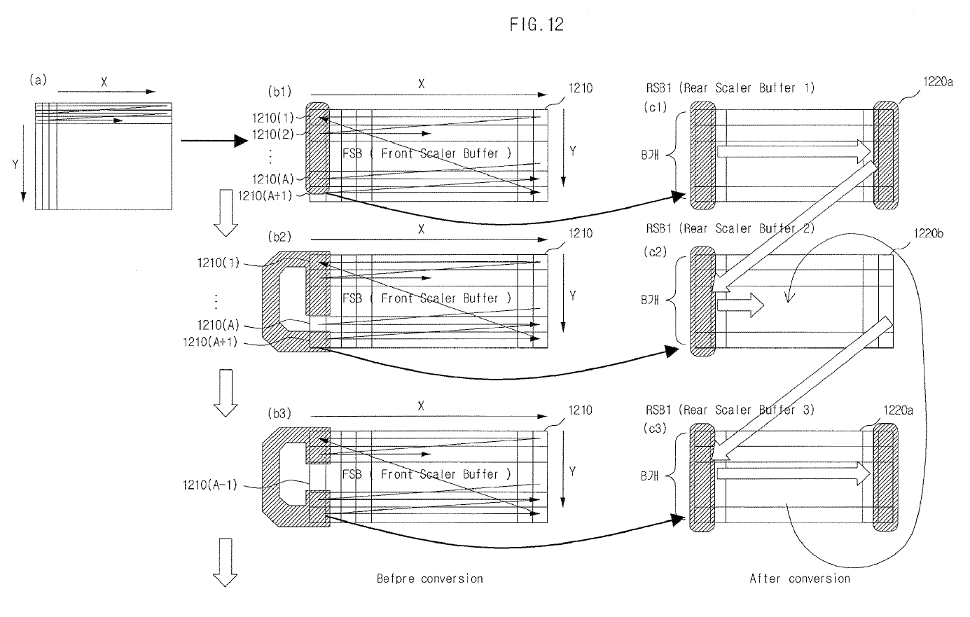

The present invention, however, can minimize the use of the memories and improve the efficiency in use of resources by using a line memory in the minimum based on the forgoing conversion processes. This will be described in detail with reference to FIG. 11 and FIG. 12.

FIG. 11 is a flowchart illustrating an image resolution converting method in accordance with an embodiment of the present invention, and FIG. 12 illustrates the method of storing and reading pixel data in and from a memory when the image resolution is converted in accordance with the present invention.

It is assumed that the image resolution of an input image is M_{H}×M_{V} (vertical resolution is M_{V}) and the image resolution of an output image capable of being represented by the optical modulator 120 is N_{H}×N_{V} (vertical resolution is N_{V}).

In a step represented by S1100, the image processing unit 150 can convert the vertical resolution of an input image to the vertical resolution of an output image capable of being displayed by the optical modulator 120.

Below is described the vertical resolution converting method.

In a step represented by S1110, the image processing unit 150 can recognize the image resolution of the input image and compare the recognized resolution with the image resolution of the output image capable of being displayed by the optical modulator 120. The greatest common denominator K of the vertical resolution M_{V} of the input image and the vertical resolution N_{V} of the output image can be computed for the conversion of the vertical resolution. Here, it is assumed that K×A=M_{V} and K×B=N_{V}.

In a step represented by S1120, an input line memory 1210 can be prepared by using the computed greatest common denominator K and the vertical resolution M_{V} of the input image, and an output line memory 1220a and 1220b can be prepared by using the computed greatest common denominator K and the vertical resolution N_{V} of the output image.

The number of the input line memories can be determined as M_{V}/K(=A)+1, and the number of the output line memories can be determined as 2×N_{V}/K(=B).

The input image can be inputted in a horizontal (i.e. X) direction in zigzags (refer to (a) in FIG. 12).

In a step represented by S1130, if the input line memories 1210(1) through 1210(A) in the quantities of A of the prepared input line memories are filled, the contraction or enlargement conversion of the vertical resolution can be performed according to the aforementioned formula 4 through formula 9. The pixel data of pixels in the quantities of B of the conversion linear image can be determined by using the vertically (i.e. Y) directional pixels in the quantities of A of the input linear image (refer to b1 and c1 in FIG. 12).

While computing the pixel data of the conversion linear image to be filled in the first output line memories 1220a in the quantities of B by using the filled input line memories 1210(1) through 1210(A) in the quantities of A, one remaining input line memory 1220(A+1) is continuously receiving the pixel data of the next horizontal line of the input image inputted in the horizontal direction in zigzags. In other words, since the pixel data of the input image is continuously inputted simultaneously with the conversion of the vertical resolution, the processing time of the all conversion processes can be shortened.

If the pixel data of the conversion linear image is completed to be stored in the first output line memory 1220a in the quantity of B, each pixel data can be successively read from the first output line memory 1220a to process the image at the next step before being transferred to the next step. At the same time, the second output line memories 1220b in the quantity of B can store the pixel data of the conversion linear image computed by using the A input line memories 1220(A+1), 1220(1), 1220(2), . . . (excluding 1220(A)) in which the pixel data of the input linear image is filled later again (refer to a2 and b2 in FIG. 12).

In the input line memory 1220, the lines in the quantities of A can be used for the vertical resolution conversion, and one remaining line is continuously receiving the pixel data of the input image.

The first output line memory 1220a and the second output line 1220b can alternately perform reading and writing. In particular, while the first output line memory 1220a is performing the writing, the second output line memory 1220b can be performing the reading. If the writing and the reading are completed, the second output line memory 1220b can start to perform the writing, and simultaneously, the first output line memory 1220a can start to perform the reading. These operations can be alternately performed.

In a step represented by S1140, if the foregoing operations are repeated K times, the vertical resolution conversion of one frame can be completed.

In a step represented by S1150, if the vertical resolution conversion is completed, the horizontal resolution can be adjusted. As described above, the width of the input image can be adjusted by changing the scanning period in order to convert the horizontal resolution of the input image. However, the resolution itself may not be converted.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. A method of converting an image resolution of an input image to a suitable resolution for an output image outputted by a display apparatus, the method comprising:
determining an image resolution of the input image;
adjusting a vertical resolution of the image resolution of the input image to be identical to a vertical resolution of the output image; and
adjusting a scanning time of a vertical line of the input image.

2. The method of claim 1, wherein, in the step of adjusting the scanning time of the vertical line, the scanning time is determined by using the vertical resolution of the input image adjusted to be identical to the vertical resolution of the output image according to a vertical and horizontal ratio of the input image.

3. The method of claim 1, wherein, in the step of adjusting the scanning time of the vertical line, the scanning time is determined according to a value that is evaluated by dividing a width of the output image by a horizontal resolution of the input image.

4. The method of claim 1, wherein the step of adjusting the scanning time of the vertical line comprises:
computing a greatest common denominator of the vertical resolution of the input image and the vertical resolution of the output image;
allotting input line memories in the quantities corresponding to the greatest common denominator and the vertical resolution of the input image and output line memories in the quantities corresponding to the greatest common denominator and the vertical resolution of the output image;
receiving pixel data of the input image successively;
performing a vertical resolution conversion if lines in the quantities of a predetermined number of the input line memories are filled; and
repeating the receiving step and the conversion performing step.

5. The method of claim 4, wherein, in the line memory allotting step, the input line memories in the quantities of {(the vertical resolution of the input image)/(the greatest common denominator)+1} are allotted.

6. The method of claim 4, wherein, in the line memory allotting step, the output line memories in the quantities of {2×(the vertical resolution of the output image)/(the greatest common denominator)} are allotted.

7. The method of claim 4, wherein adjusting a vertical resolution of one image frame is completed by repeating the repeating step as many times as the greatest common denominator.

8. The method of claim 1, wherein, if the input image is contracted according to the output image, the vertical resolution of the input image is contracted in the vertical resolution adjusting step and the scanning time is shortened in the scanning adjusting step.

9. The method of claim 1, wherein, if the input image is enlarged according to the output image, the vertical resolution of the input image is enlarged in the vertical resolution adjusting step and the scanning time is lengthened in the scanning adjusting step.

10. A display apparatus comprising:
a projection unit, loading image information corresponding to an image control signal on a beam of light emitted from a light source and projecting the beam of light on a screen; and
an image processing unit, receiving an image signal of an frame, converting an image resolution of an input image corresponding to the image signal, inputted according to the image resolution of the output image, to a suitable resolution for a physical characteristic of the projection unit, generating the image control signal corresponding to the converted input image; and outputting the generated image control signal to the projection unit.

11. The apparatus of claim 10, wherein the image processing unit comprises:
a vertical resolution adjusting unit, converting the vertical resolution of the input image to be identical to the vertical resolution of the output image; and
a horizontal resolution adjusting unit, adjusting a width of the input image to be projected through the projection unit by adjusting a scanning time of a vertical line of the input image.

12. The apparatus of claim 11, wherein the horizontal resolution adjusting unit determines the scanning time by using the vertical resolution of the input image adjusted to be identical to the vertical resolution of the output image according to a vertical and horizontal ratio of the input image.

13. The apparatus of claim 11, wherein the horizontal resolution adjusting unit determines the scanning time according to a value that is evaluated by dividing a width of the output image by a horizontal resolution of the input image.

14. The apparatus of claim 11, wherein the vertical resolution adjusting unit comprises:
an image analyzing unit, computing a greatest common denominator of the vertical resolution of the input image and the vertical resolution of the output image;
a memory allotting unit, allotting input line memories in the quantities corresponding to the greatest common denominator and the vertical resolution of the input image and output line memories in the quantities corresponding to the greatest common denominator and the vertical resolution of the output image;
an input unit, receiving pixel data of the input image successively; and
a conversion performing unit, performing a vertical resolution conversion if lines in the quantities of a predetermined number included in the input line memories are filled.

15. The apparatus of claim 14, wherein the memory allotting unit allots the input line memories in the quantities of {(the vertical resolution of the input image)/(the greatest common denominator)+1}.

16. The apparatus of claim 14, wherein the memory allotting unit allots the input line memories in the quantities of {2×(the vertical resolution of the output image)/(the greatest common denominator)}.

17. The apparatus of claim 14, wherein the conversion performing unit completes adjusting a vertical resolution of one image frame by repeating the vertical resolution conversion as many times as the greatest common denominator.

18. The apparatus of claim 10, wherein the projection unit comprises:
an optical modulator, outputting a modulated beam of light corresponding to a linear image by modulating an incident beam of light according to an inputted driving signal;
a driving circuit, converting the inputted image control signal to the driving signal and outputting the driving signal to the optical modulator;
a scanner, rotating according to a scanner control signal to scan the modulated beam of light transferred from the optical modulator on a screen and displaying a two-dimensional image; and
the light source, emitting the incident beam of light to the modulator according to an inputted light source control signal,
whereas the image processing unit controls an image projection performed by the optical modulator by providing the light source and the scanner with the light source control signal and the scanner control signal, synchronized with the image control signal.

19. The apparatus of claim 18, wherein the optical modulator comprises:
a plurality of micro-mirrors, arranged in a line to reflect the incident beam of light; and
driving means, moving the micro-mirrors up and down according to the driving signal,
whereas each of the micro-mirrors deals with a pixel of the screen.
